(19) United States
(12) Patent Application Publication
(10) Pub. No.: US 2008/0210028 A1
(43) Pub. Date: Sep. 4, 2008

(54) DRIVING MECHANISM AND CUTTING APPARATUS HAVING THE DRIVING MECHANISM

(75) Inventor: Seishi Sato, Ota-Ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/034,225

(22) Filed: Feb. 20, 2008

(30) Foreign Application Priority Data
Mar. 2, 2007 (JP) 2007-52527

(51) Int. Cl. F16H 25/20; B26D 5/08

(52) U.S. Cl. 74/89.23; 83/613

(57) ABSTRACT

A driving mechanism having a driving unit in which a drive source is connected to a feed screw shaft and a feed nut is in screw engagement with the feed screw shaft and connected to an active element through a sliding body, wherein the active element is moved by being driven by the driving unit. An inner ring of a bail bearing for supporting the feed screw shaft is fixed to the outer periphery of a free end portion of the feed screw shaft, and an outer ring elastic body which supports an outer ring of the ball bearing slidably in the axial direction of the feed screw shaft and which absorbs vibration of the feed screw shaft is disposed at the inner periphery of a tubular portion for containing the ball, bearing at a terminal support portion.

### FIELD OF THE INVENTION

The present invention relates to a driving mechanism having the function of moving various active elements.

A wafer on which devices such as ICs and LSIs are formed in areas demarcated by planned dividing lines is divided (diced) into individual chips by a method in which a cutting blade rotated at a high speed is applied to the planned dividing lines or a method in which the wafer is irradiated with a laser beam along the planned dividing lines. For dividing (dicing) the wafer in this manner, for example, a dicing apparatus as described in Japanese Patent Laid-open No. 2006-294913 is used. As shown in FIG. 1, the dicing apparatus described in the publication has a chuck table 100 for holding a wafer W, and the chuck table 100 can be moved in the direction of arrow in FIG. 1 when driven by a driving mechanism 101.

The driving mechanism 101 includes a feed screw shaft 102 disposed along the moving direction of the chuck table 100, a drive source 103 connected to one end of the feed screw shaft 102 so as to turn the feed screw shaft 102, a terminal support part 104 for supporting a free end part 102a, or the other end, of the feed screw shaft 102 so that the feed screw shaft 102 can be rotated on an inner peripheral surface of a tubular part 104a shown in FIG. 2, a pair of guide rails 105 disposed in parallel to the feed screw shaft 102, a sliding body 106 capable of being slid in engagement with the guide rails 105f and a feed nut (not shown) in screw engagement with the feed screw shaft 102 and connected to the sliding body 106. The driving mechanism 101 is so configured that, with the feed screw shaft 102 driven by the drive source 103 to rotate, the sliding body 106 connected to the feed nut is moved in an X-axis direction while being guided by the guide rails 105, and, attendant on this, the chuck table 100 fixed to the sliding body 106 is also moved in the X-axis direction. As shown in FIG. 2, at the terminal support part 104, the free end part 102a of the feed screw shaft 102 is rotatably supported by a ball bearing 107.

The wafer to be diced is held, by the chuck table 100 shown in FIG. 1. The wafer held by the chuck table 100 is moved under driving by the driving mechanism 101 and a cutting blade being in high-speed rotation is lowered to cut the wafer along a planned dividing line, whereby the wafer is cut along the planned dividing line. In addition, while index feeding of the cutting blade is made by the interval, between the adjacent planned dividing lines at a time, the chuck table 100 is moved in a similar manner, whereby the wafer is cut sequentially along the planned dividing lines. Furthermore, the chuck table 100 is rotated by 90 degrees, and similar cutting is conducted, whereby the wafer is split along all the planned dividing lines into individual chips.

However, there is a problem that, when, for example, a wafer as thin as 100 μm or below or a wafer with a die bonding pressure sensitive adhesive film (called “die attachment film”) adhered to the back side thereof is held by the chuck table 100 shown in FIG. 1 and is diced, a comparatively large amount of chippings is generated at peripheral edge parts of the individual chips formed by the dicing, whereby the quality of the chips is lowered. The case of the problem is as follows. In consideration of thermal expansion of the feed, screw shaft 102 due to rotation, the outside diameter of the outer ring 107a of the ball bearing 107 is set to be smaller than the inside diameter of the tubular part 104a by several tens of micrometers. Therefore, when machining feeding of the chuck table 100 in the X-axis direction is made by the driving mechanism 101, vibration is generated in the feed screw shaft 102 and in the sliding body 106, and the vibration is transmitted to the chuck table 100, resulting in vibration of the wafer. This vibration is considered to cause the above-mentioned problem.

In addition, there is another problem. When the speed at which the chuck table 100 is fed by the driving mechanism 101 is enhanced, productivity of dicing can be enhanced. However, a rise in the rotating speed of the feed screw shaft 102 for this purpose results in that the feed screw shaft 102 approaches a dangerous speed, at which the feed screw shaft 102 would swing like a rope in rope skipping, to be eventually broken. Such problems arising from the vibration of the feed screw shaft may occur not only in the driving mechanism for moving the chuck table 100 but also in other driving mechanisms having similar configurations.

### SUMMARY OF THE INVENTION

Accordingly, it is an object of the present invention to provide a driving mechanism in which a feed screw shaft connected at its one end with a drive source is rotatably supported at its other end and a sliding body connected to a feed nut being in screw engagement with the feed screw shaft is moved so as to move an active element, wherein the feed screw shaft is prevented from vibration.

In accordance with an aspect of the present invention, there is provided a driving mechanism including a guide rail, a sliding body capable of being slid in engagement with the guide rail, a driving means for moving the sliding body along the guide rail, and an active element fixed to the sliding body, wherein the driving means includes a drive source, a feed screw shaft connected to the drive source so as to be rotatable, a terminal support means for rotatably supporting a free end part of the feed screw shaft, and a feed nut in screw engagement with the feed screw shaft and connected to the active element; the terminal support means includes a tubular part for containing a bail bearing, and an outer ring elastic body disposed at the inner periphery of the tubular part, supporting an outer ring of the ball bearing slidably in the axial direction of the feed screw shaft, and operative to absorb vibration of the feed screw shaft; and an inner ring of the ball bearing for supporting the feed screw shaft is fixed to the outer periphery of the free end part of the feed screw shaft.

Preferably, an inner ring elastic body is interposed between the free end part of the feed screw shaft and the inner ring of the ball bearing. Preferably, the ball bearing includes a first, ball bearing and a second ball bearing, and the outer ring elastic body includes a first outer ring elastic body for supporting an outer ring of the first bail bearing slidably in the axial direction of the feed screw shaft, and a second outer ring elastic body for supporting an outer ring of the second ball bearing slidably in the axial direction of the feed screw shaft.

In the case where the bail bearing includes the first, ball bearing and the second ball bearing, the inner ring elastic body desirably includes a first inner ring elastic body interposed between the free end part of the feed screw shaft and an inner ring of the first ball bearing, and a second inner ring elastic body interposed between the free end part of the feed screw shaft and an inner ring of the second ball bearing. Examples of the inner ring elastic body or the outer ring elastic body includes a nitrile tributyl rubber coated with polybutylene naphthalate.

In accordance with another aspect of the present invention, there is provided a cutting apparatus including: a driving mechanism as above-mentioned, and cutting means for cutting a wafer; wherein the active element is a chuck table for holding the wafer; and the cutting means has a cutting blade attached to a rotatable spindle, and is movable in a direction orthogonal to the moving direction of the chuck table.

According to the present invention, the outer ring elastic body is disposed at the inner periphery of the tubular part of the terminal support part, and the outer ring of the ball bearing is supported by the outer ring elastic body slidably in the axial direction of the feed screw shaft. This ensures that even when the feed screw shaft is vibrated, the vibration is absorbed by the outer ring elastic body, so that the vibration of the feed screw shaft can be suppressed, and vibration of the active element connected to the nut being in screw engagement can be suppressed. In addition, in the case where, the feed screw shaft is thermally expanded, the outer ring of the ball bearing slides on the outer ring elastic body, so that no buckling load is exerted on the feed screw shaft, which, together with the restraint of vibration, permits rotation of the components at higher speeds. Besides, where the inner ring elastic body is interposed between the free end part of the feed screw shaft and the inner ring of the bail bearing, the vibration-absorbing effect is enhanced further, whereby the vibration of the active element can be further suppressed.

Where the ball bearing includes the first bail bearing and the second ball bearing and the outer rings of the ball bearings are supported respectively by the first outer ring elastic body and the second outer ring elastic body in the axial direction of the feed screw shaft, stability is increased and it is made more difficult for the feed screw shaft to vibrate. In addition, where the first inner ring elastic body and the second inner ring elastic body are interposed respectively between the free end part of the feed screw shaft and the inner ring of the first bail bearing and between the free end part and the inner ring of the second bail bearing, the vibration-absorbing effect is further enhanced. Besides, where the inner ring elastic body or the outer ring elastic body is formed of a nitrile butyl rubber coated with, polybutylene naphthalate, the coefficient of friction on the part making contact with the outer ring or inner ring of the ball bearing is low, so that the influence of the friction on the rotating speed of the feed screw shaft is low.

In the cutting apparatus including the driving mechanism according to the present invention and the cutting means which has the cutting blade attached to the rotatable spindle and which is movable in a direction orthogonal to the moving direction of the chuck table, when a wafer is cut by the cutting blade while the chuck table holding the wafer is moved, the vibration of the chuck table is suppressed to a low level, so that there is little possibility of generation of chippings on the individual chips formed by dicing the wafer.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a driving mechanism according to the prior art;

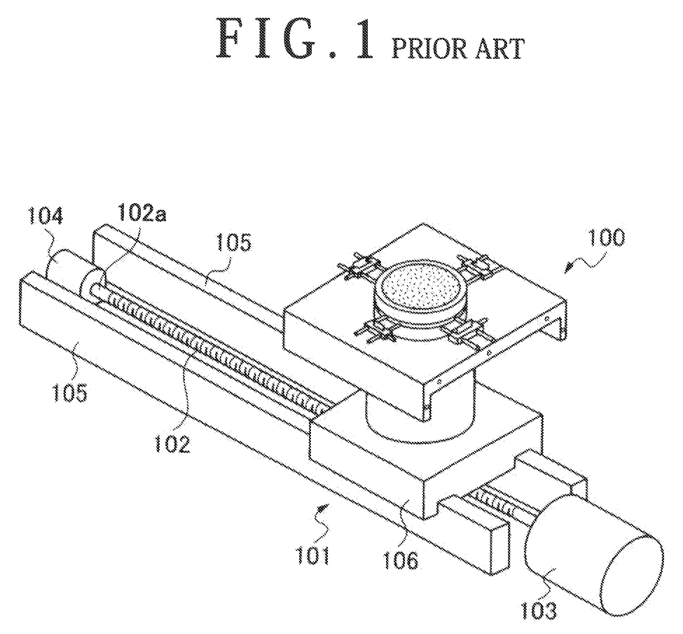

FIG. 2 is a sectional view of a part of the driving mechanism according to the prior art;

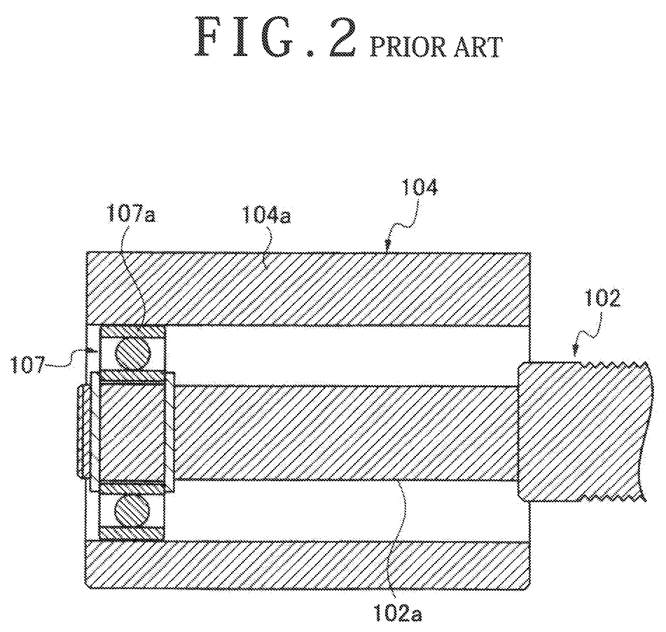

FIG. 3 is a perspective view of an embodiment of the cutting apparatus according to the present invention;

FIG. 4 is a sectional view of a part of a driving mechanism according to the present invention; and

FIG. 5 is an exploded perspective view of a part of the driving mechanism according to the present invention.

### DETAILED DESCRIPTION OF THE PREFERRED EMBODIMENTS

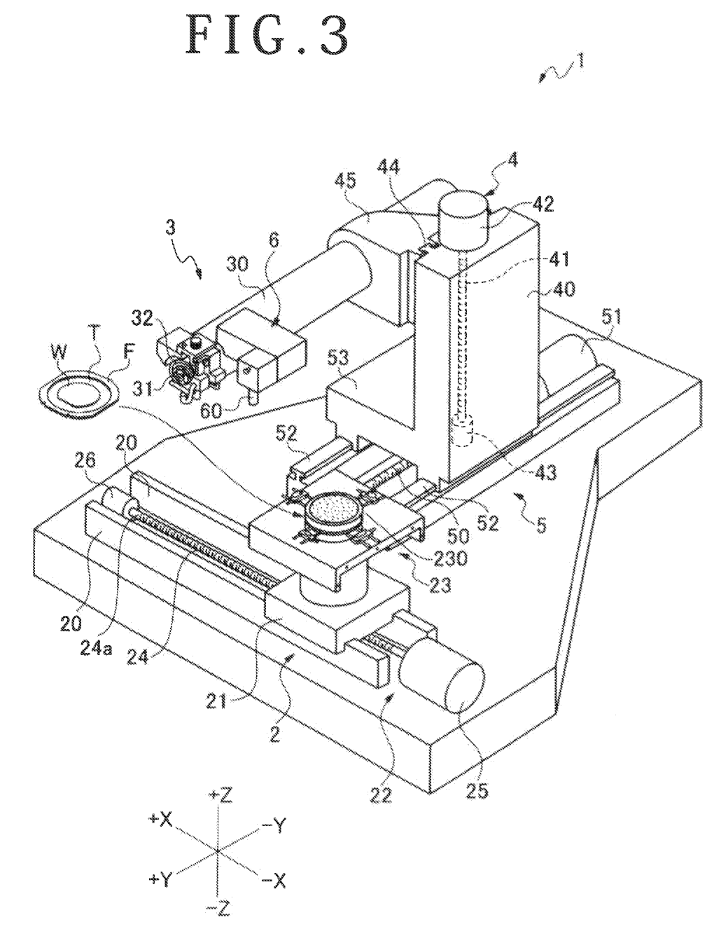

A cutting apparatus 1 shown in FIG. 3 is an apparatus for cutting various works, which has at least a driving mechanism 2 having the function of moving a chuck, table 23 for holding the work. The driving mechanism 2 includes a pair of guide rails 20 disposed in an X-axis direction, a sliding body 21 capable of being slid in engagement with the guide rails 20, a driving unit 22 for moving the sliding body 21 along the guide rails 20, and the chuck table 23 which is an active element fixed to the sliding body 21.

The driving unit 22 includes a feed, screw shaft 24 disposed in parallel, to the guide rails 20, a drive source 25 connected to one end of the feed screw shaft 24 and operative to rotate the feed screw shaft 24, a terminal support part 26 for rotatably supporting a free end part 24a of the feed screw shaft 24, and a feed nut (not shown) in screw engagement with the feed screw shaft 24 and connected to the chuck table 23 (which is the active element) through the sliding body 21. With the feed screw shaft 24 driven by the drive source 25 to rotate, the sliding body 21 connected to the feed nut is moved in the X-axis direction while being guided by the guide rails 20, and, attendant, on this, the chuck table 23 fixed to the sliding body 21 is also moved in the X-axis direction. The rotating speed of the feed screw shaft 24 and the moving velocity of the chuck table 23 are in a proportional relationship. Incidentally, the chuck table 23 includes a holding part 230 for holding the work, and a rotational driving part 231 for rotating the holding part 230, and the holding part 230 can be rotated by a desired angle under driving by the rotational driving part 231.

On the upper side of the moving path of the chuck table 23, a cutting means 3 is disposed which cuts the work held by the chuck table 23. The cutting means 3 has a cutting blade 32 attached to the tip of a spindle 31 rotatably supported by a housing 30. The cutting means 3 can be moved in a Z-axis direction when driven by a cutting feeding means 4, and can be moved in a Y-axis direction when driven by an indexing feeding means 5; thus, the cutting means 3 can be moved in directions orthogonal to the moving direction of the chuck table 23.

An alignment means 6 for detecting that area of the wafer which is to be cut is fixed to a side part of the housing 30. The alignment means 6 has an imaging unit 60. The alignment means 6 has the function of detecting a planned dividing line to be cut, based on an image of the wafer obtained by the imaging unit 60.

The cutting feeding means 4 includes: a feed screw shaft 41 disposed in the Z-axis direction at a one-side surface of a wall part 40; a drive source 42 connected to one end of the feed screw shaft 41 and operative to rotate the feed screw shaft 41; a terminal, support part 43 for rotatably supporting a free end part, or the other end, of the feed screw shaft 41; a guide rail 44 disposed in parallel to the feed screw shaft 41; and a sliding body 45 which is connected to a feed nut (not shown) being in screw engagement with the feed screw shaft 41 and which can be slid in engagement with the guide rail 44. The sliding body 45 is moved in the Z-axis direction while being guided by the guide rail 44 under driving by the drive source 42, and, attendant on this, the cutting means 3 supported by the sliding body 44 is moved upward and downward in the Z-axis direction.

The indexing feeding means 5 includes: a feed screw shaft 50 disposed along the Y-axis direction; a drive source 51 connected to one end of the feed screw shaft 50 and operative to rotate the feed screw shaft 50; a terminal support part (not shown) for rotatably supporting a free end part, or the other end, of the feed screw shaft 50; a guide rail 52 disposed in parallel, to the feed screw shaft 50; and a sliding body 53 which is connected to a feed nut (not shown) being in screw engagement with the feed screw shaft 50 and which can be slid in engagement with the guide rail 52. The sliding body 53 is moved in the Y-axis direction while being guided by the guide rail 52 under driving by the drive source 51, and, attendant on this, the wall part 40 formed as one body with the sliding body 53 and the cutting means 3 are moved, in the Y-axis direction.

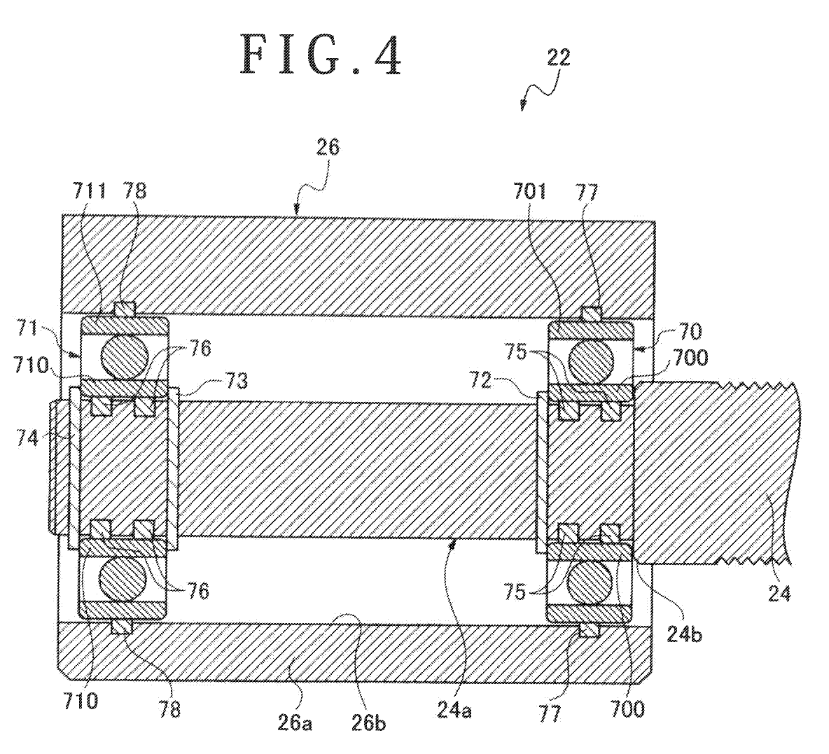

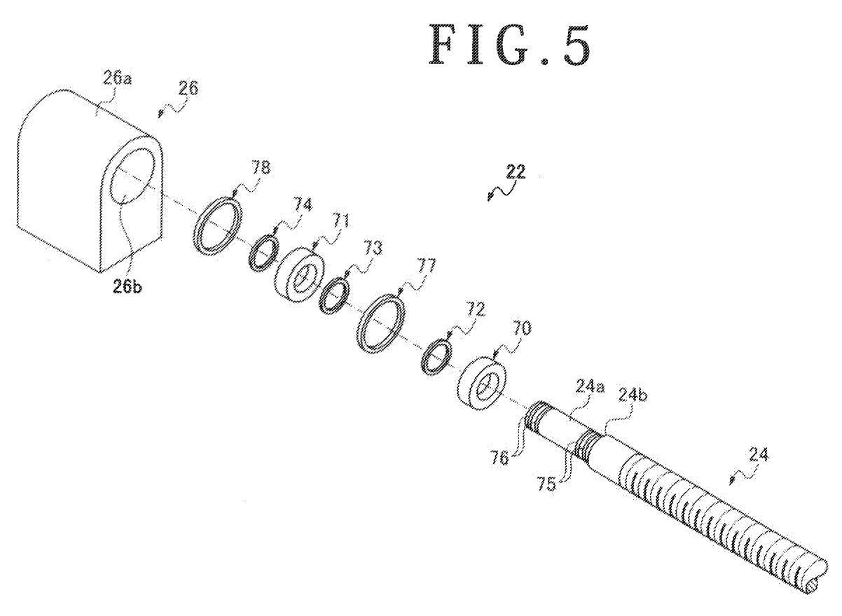

As shown in FIGS. 4 and 5, in the driving mechanism 2, an inner ring 700 of a first ball bearing 70 and an inner ring 710 of a second ball, bearing 71 are fixed, to the free end part 24a of the feed screw shaft 24. The first ball bearing 70 is fixed by being clamped between a stop ring 72 and an enlarged diameter part 24b of the feed screw shaft 24, and the second ball bearing 71 is fixed by being clamped between two stop rings 73, 74. The stop rings 72, 73 and 74 are formed, for example, of copper, and is attached by heating and caulking.

First inner ring elastic bodies 75 and second inner ring elastic bodies 76 are embedded in the outer periphery of the free end part 24a of the feed screw shaft 24 in the state of slightly protruding from the outer periphery, in such a manner that, the first inner-ring elastic bodies 75 and the second inner ring elastic bodies 76 are interposed between the free end part 24a of the feed screw shaft 24 and the inner rings 700, 710, respectively. While the first inner ring elastic bodies 75 and the second inner ring elastic bodies 76 are provided in twos in the embodiment, shown, they may be provided singly or in threes or more.

The terminal support part 26 has the tubular part 26a for containing the first ball bearing 70, the second ball bearing 71 and the free end part 24a of the feed screw shaft 24. A first outer ring elastic body 77 and a second outer ring elastic body 78 are embedded in the inner periphery 26b of the tubular part 26a in the state of slightly protruding from the inner periphery 26b. The first outer ring elastic body 77 supports an outer ring 701 of the first ball bearing 70 slidably in the axial direction of the feed screw shaft 24, and the second outer ring elastic body 78 supports an outer ring 711 of the second bail bearing 71 slidably in the axial, direction of the feed screw shaft 24.

As the first inner ring elastic bodies 75, the second inner ring elastic bodies 76, the first, outer ring elastic body 77 and the second outer ring elastic body 78, nitrilebutyl rubber coated with polybutylene naphthalate, such as Teflon (trademark), can be used. For example, Sunply Ring (trademark) produced by Mitsubishi Cable Industries, Ltd. can be used.

Referring to FIG. 3, the operations in cutting the wafer W will be described below. The wafer W to be diced is held by the chuck table 23 in the state of being united to a frame F through a tape T. With the chuck table 23 moved in the X-axis direction under the function of the driving mechanism 2, the wafer W is moved to a position just under the imaging unit 60, where the surface of the wafer W is imaged, a planned dividing line along which the wafer W is to be cut is detected, and position matching between the planned dividing line and the cutting blade 32 in the Y-axis direction is carried out.

In the condition where the position matching has been made, the chuck table 23 is moved in the X-axis direction, and the cutting means 3 with the cutting blade 32 in high-speed rotation is lowered so as to cause the cutting blade 32 to cut the wafer W along the planned dividing line detected, whereby the wafer W is cut along the planned dividing line. In addition, while indexing feeding of the cutting means 3 is made in the Y-axis direction by the interval between the adjacent planned dividing lines at a time, the chuck table 23 is moved in a similar manner, whereby the wafer W is cut sequentially along the planned dividing lines. Further, the chuck table 23 is rotated by 90 degrees, then cutting is similarly conducted, whereby the wafer W is split along all the planned dividing lines into individual chips.

Thus, at the time of cutting, the chuck table 23 is repeatedly moved in the X-axis direction by the function of the driving mechanism 2. Therefore, if the feed screw-shaft 24 is vibrated, the vibration is transmitted to the chuck table 23 constituting an active element, and the cutting blade 32 being rotated is pressed against the wafer W being vibrated, so that side walls of a cut groove in the wafer W (peripheral edge parts of device chips after the dicing) are susceptible to chipping. However, since the vibration of the feed screw shaft 24 is absorbed by the first outer ring elastic body 77 and the second outer ring elastic body 78 shown in FIGS. 4 and 5, the vibration of the wafer W is suppressed, and the possibility of chipping is lowered. Where the first inner ring elastic bodies 75 and the second inner ring elastic bodies 76 are further disposed, the vibration of the wafer W is further suppressed, and the possibility of chipping is further lowered.

In addition, when the feed screw shaft 24 of the driving mechanism 2 is made to be less susceptible to vibration, it becomes possible to enhance the rotating speed of the feed screw shaft 24, so that the moving velocity of the chuck table 23 can be enhanced, and productivity of cutting can be enhanced. Specifically, in a conventional cutting apparatus not having any inner-ring elastic body and any outer ring elastic body in its driving mechanism, the rotating speed of the feed screw shaft reaches a dangerous speed when the moving velocity of the chuck table is raised to 800 mm/sec. On the other hand, the feed screw shaft 24 did not reach a dangerous speed even when the moving velocity of the chuck table 23 was raised to 1200 mm/sec by the driving mechanism 2 shown in FIGS. 3 to 5.

Incidentally, the feed screw shaft 24 did not reach a dangerous speed even when the moving velocity of the chuck table 23 was raised to 1200 mm/sec, also in the case where the inner ring 700 of the first ball bearing 70 and the inner ring 710 of the second ball bearing 71 were caulked with the free end part 24a of the feed screw shaft 24 and where only the first outer ring elastic body 77 and the second outer ring elastic body 78 were interposed between the outer ring 701 of the first bail bearing 70 and the tubular part 26a of the terminal support part 26 and between the outer ring 711 of the second bail bearing 71 and the tubular part 26a.

Besides, while two bail bearings are contained in the tubular part 26a and the first outer ring elastic body 77 and the second outer ring elastic body 78 are disposed correspondingly to the outer rings of the ball bearings in the embodiment above, only one ball bearing may be contained, in the tubular part 26a. In that case, arrangement of at least one outer ring elastic body for supporting the outer ring of the one bail bearing slidably in the axial direction of the feed screw shaft 24 results in that the vibration of the feed screw shaft 24 can be absorbed by the outer ring elastic body.

Incidentally, while the case where the driving mechanism based on the present invention is applied to the mechanism for moving the chuck table 23 in the cutting apparatus 1 has been described in the embodiment above, the driving mechanism based on the present invention may be applied to the cutting feeding means 4 or the indexing feeding means 5 in the cutting apparatus 1. In that case, the active element is the cutting means 3. Furthermore, the apparatus to which the driving mechanism based on the present invention is to be applied is not limited to the cutting apparatus.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A driving mechanism including a guide rail, a sliding body capable of being slid in engagement with said guide rail, driving means for moving said sliding body along said guide rail, and an active element fixed to said sliding body,
said driving means comprising:
a drive source,
a feed screw shaft connected to said drive source so as to be rotatable,
terminal support means for rotatably supporting a free end portion of said feed screw shaft, and
a feed nut in screw engagement with said feed screw shaft and connected to said active element;
said terminal support, means including
a tubular portion for containing a ball bearing, and
an outer ring elastic body disposed at the inner periphery of said tubular portion, supporting an outer ring of said ball bearing slidably in the axial direction of said feed screw shaft, and operative to absorb vibration of said feed screw shaft; wherein
an inner ring of said ball bearing for supporting said feed screw shaft is fixed to the outer periphery of said free end portion of said feed screw shaft.

2. The driving mechanism as set forth in claim 1, wherein an inner ring elastic body is interposed between said free end portion of said feed screw shaft and said inner ring of said ball bearing.

3. The driving mechanism as set forth in claim 2, wherein:
said ball bearing includes a first ball bearing and a second ball bearing; and
said outer ring elastic body includes a first outer ring elastic body for supporting said outer ring of said first ball bearing slidably in the axial direction of said feed screw shaft, and a second outer ring elastic body for supporting said second ball bearing slidably in the axial direction of said feed screw shaft.

4. The driving mechanism as set forth in claim 3, wherein said inner ring elastic body includes a first inner ring elastic body interposed between said free end portion of said feed screw shaft and an inner ring of the first ball bearing, and a second inner ring elastic body interposed between said free end portion of said feed screw shaft and an inner ring of the second ball bearing.

5. The driving mechanism as set forth in claim 1, wherein said outer ring elastic body is a nitrilebutyl rubber coated with polybutylene naphthalate.

6. The driving mechanism as set forth in claim 2, wherein said inner ring elastic body is a nitrilebutyl rubber coated with polybutylene naphthalate.

7. A cutting apparatus comprising:
a driving mechanism as set forth in claim 1; and
cutting means for cutting a wafer,
wherein said active element is a chuck table for holding said wafer, and
said cutting means has a cutting blade attached to a rotatable spindle, and is movable in a direction orthogonal to the moving direction of said chuck table.
